(19) United States
(12) Patent Application Publication
(10) Pub. No.: US 2026/0275221 A1
(43) Pub. Date: Sep. 17, 2026

(54) ETHYLENE-RICH DIENE POLYMERS HAVING A POLYVINYLPYRIDINE BLOCK AND THEIR USE IN ENGINE LUBRICANT COMPOSITIONS

(71) Applicant: Compagnie Generale Des Etablissements Michelin, Clermont-Ferrand (FR)

(72) Inventors: Thibaut SOUCHARD, Clermont-Ferrand (FR); Julien THUILLIEZ, Clermont-Ferrand (FR); Robert NGO, Clermont-Ferrand (FR)

(73) Assignee: Compagnie Generale Des Etablissements Michelin, Clermont-Ferrand (FR)

(21) Appl. No.: 18/877,733

(22) PCT Filed: Jun. 8, 2023
(86) PCT No.: PCT/EP2023/065359

§ 371 Date: Dec. 20, 2024

(30) Foreign Application Priority Data
Jun. 23, 2022 (FR) 2206247

(51) Int. Cl. C10M 107/42; C08F 301/00

(52) U.S. Cl. CPC C10M 107/42; C08F 301/00

(57) ABSTRACT

Block polymers and engine lubricant compositions containing the block polymers and a mineral base oil are provided. The block polymers contain a first block and a second block. The first block is a copolymer of 1,3-butadiene and ethylene, containing more than 90 mol % of ethylene units, the molar percentage being expressed relative to the total number of constituent repeat units of the first block. The second block is a homopolymer of a vinylpyridine.

### CROSS REFERENCE TO RELATED APPLICATIONS

This U.S. patent application is a national phase entry of PCT Patent Application No. PCT/EP2023/065359, filed Jun. 8, 2023, which claims priority to French Patent Application No. FR 2206247, filed Jun. 23, 2022, the entire contents of which are incorporated herein by reference in their entirety.

### BACKGROUND

### 1. Technical Field

The field of the invention is that of block polymers containing an ethylene-rich diene block and a polyvinylpyridine block which are intended for use in engine oils as additives for improving the high-temperature performance of these oils.

### 2. Related Art

Engine oils, which are lubricating compositions containing mineral base oils, are used in an engine to minimize, under cold conditions, the energy losses caused by friction in the engine and to maintain, under hot conditions, a continuous film of lubricant on the lubricated components of the engine. It is important for the viscosity of the lubricating composition to decrease as little as possible during operation under hot conditions in order to avoid breaking the lubricating film.

Mineral base oils represent a major constituent of the lubricating compositions which are engine oils. The viscosity of a mineral base oil decreases with an increase in the temperature and increases with a decrease in the temperature. It follows that the viscosity of a lubricating composition containing predominantly a mineral base oil also experiences a variation in its viscosity with the temperature.

In order to weaken the effect of a rise in temperature on the viscosity of a lubricating composition, it is known to add additives to a mineral base oil. These additives serve to thicken the lubricating composition when the temperature increases in order to partially remedy the drop in viscosity under hot conditions. They generally increase the high temperature viscosity in order to counter the decrease in viscosity of the mineral base oil. These thickening additives are generally polymers. The two main families of polymers sold for this purpose are polymers having an ester function, such as poly(meth)acrylates, and hydrocarbon-based polymers, such as polyisobutylenes, copolymers of ethylene and of propylene, also known as OCPs, hydrogenated copolymers of diene and of styrene, and also hydrogenated polydienes.

### SUMMARY

The applicant has discovered that block polymers containing a polyvinylpyridine block and a block which is a copolymer of ethylene and 1,3-butadiene and which is rich in ethylene increased the viscosity of engine oils at high temperature as effectively as OCPs.

Thus, a first subject of the invention is a block polymer containing a first block and a second block, the first block being a copolymer of 1,3-butadiene and ethylene, containing more than 90 mol % of ethylene units, the molar percentage being expressed relative to the total number of constituent repeat units of the first block, the second block being a homopolymer of a vinylpyridine.

A second subject of the invention is a lubricating composition comprising a mineral base oil and a block polymer in accordance with the invention.

### DETAILED DESCRIPTION OF EXAMPLE EMBODIMENTS

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

Unless otherwise indicated, the contents of the units in the first block are expressed as a molar percentage relative to all of the constituent repeat units of the first block.

The compounds mentioned in the description may be of fossil origin or may be biobased. In the latter case, they can result, partially or completely, from biomass or be obtained, partially or completely, from renewable starting materials resulting from biomass. Similarly, the compounds mentioned may also originate from the recycling of already-used materials, i.e. they may partially or completely result from a recycling process, or else be obtained from starting materials which themselves result from a recycling process.

The expression “based on” used to define the constituents of a catalytic system (or catalytic composition) is understood to mean the mixture of these constituents, or the product of the reaction of a portion or all of these constituents with one another.

The essential feature of the block polymer in accordance with the invention is that it contains two blocks.

The first constituent block of the block polymer in accordance with the invention is a copolymer of ethylene and a 1,3-butadiene. The constituent monomer units of the first block are those resulting from the copolymerization of ethylene and of 1,3-butadiene.

The ethylene units present in the first block represent more than 90 mol % of the total number of constituent repeat units of the first block. Preferably, the ethylene units present in the first block represent less than 97 mol % of the total number of constituent repeat units of the first block. As is known, the term “ethylene unit” means a unit which contains the —(CH₂—CH₂)— subunit.

As is known, the 1,3-butadiene may be inserted into a growing polymer chain by a 1,4 or 1,2 insertion to give rise to the formation of the 1,3-butadiene unit of 1,4 configuration or the 1,3-butadiene unit of 1,2 configuration, respectively. When the first block contains units of the 1,3-butadiene in the 1,4 configuration, 1,4-trans units preferentially represent more than 50% of the units of 1,4 configuration, more preferentially more than 80% of the units of 1,4 configuration.

The first block may additionally contain 1,2-cyclohexanediyl subunits, also referred to as 1,2-cyclohexanediyl units of formula (I).

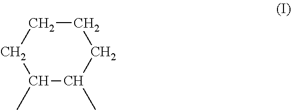

The presence of these cyclic structures in the first block results from a highly specific insertion of the ethylene and the 1,3-butadiene during their copolymerization. The mechanism for obtaining such a microstructure is described for example in Macromolecules 2009, 42, 3774-3779. The content of 1,2-cyclohexanediyl subunits in the first block may vary depending on the polymerization conditions for forming the first block, for example depending on the respective contents of ethylene and 1,3-butadiene in the polymerization medium, depending on the pressure in the polymerization reactor, depending on the catalytic polymerization system, as is described for example in the documents WO 2021/023924, WO 2017/103543 and WO 2018/104669.

According to a particularly preferential embodiment of the invention, the first block contains 1,2-cyclohexanediyl subunits. Preferably, the molar content of 1,2-cyclohexanediyl subunits in the first block is less than 10% of the total number of constituent repeat units of the first block. More preferentially, it varies from 1% to less than 10% of the total number of constituent repeat units of the first block.

According to a particularly preferential embodiment of the invention, the first block is a statistical copolymer of ethylene and 1,3-butadiene.

The essential feature of the second constituent block of the block polymer in accordance with the invention is that it is a homopolymer of a vinylpyridine. The vinylpyridine of which the monomer units constitute the second block is a vinylpyridine as defined in the described embodiments of the process in accordance with the invention. Preferably, the vinylpyridine is 4-vinylpyridine, 2-vinylpyridine or the mixture thereof. More preferentially, the vinylpyridine is 4-vinylpyridine.

The molar content of the vinylpyridine units present in the second block can be less than 1% or much greater than 1% of the total number of constituent repeat units of the first block. It is preferably greater than 0.1% of the total number of constituent repeat units of the first block. It is preferably less than 20% of the total number of constituent repeat units of the first block.

The block polymer according to the invention is preferentially a diblock. When the block polymer is a diblock, it is typically of formula A-B, wherein A denotes the first block and B denotes the second block.

The block polymer in accordance with the invention can be prepared by a process of subsequent polymerization. It comprises the polymerization of a monomer mixture of ethylene and the 1,3-butadiene in the presence of a catalytic system in order to form the first block, followed by the homopolymerization of a vinylpyridine in order to form the second block.

The catalytic system is based on at least one metallocene of formula (I) and an organomagnesium compound

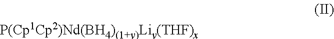

Cp¹ and Cp² being selected from the group consisting of fluorenyl groups, cyclopentadienyl groups and indenyl groups, the groups being substituted or unsubstituted,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y is an integer equal to or greater than 0,
x is an integer or non-integer equal to or greater than 0.

In the formula (II), the neodymium atom is connected to a ligand molecule consisting of the two groups Cp¹ and Cp² which are connected together by the bridge P. Preferably, the symbol P, denoted by the term bridge, corresponds to the formula ZR¹R², Z representing a silicon atom and R¹ and R², which are identical or different, representing an alkyl group comprising from 1 to 20 carbon atoms. More preferentially, the bridge P is of formula SiR¹R², R¹ and R² being identical and as defined previously. More preferentially still, P corresponds to the formula SiMe₂.

As substituted cyclopentadienyl, fluorenyl and indenyl groups, mention may be made of those substituted with alkyl groups having 1 to 6 carbon atoms or with aryl groups having 6 to 12 carbon atoms or else with trialkylsilyl groups, such as SiMe₃. When the ligands Cp¹ and Cp² are substituted, they are preferentially substituted with methyl groups, with butyl groups, notably tert-butyl groups, or with trimethylsilyl groups. These groups are preferential regardless of the embodiment of the invention. The choice of the groups is also guided by the accessibility to the corresponding molecules, which are the substituted cyclopentadienes, fluorenes and indenes, since said molecules are commercially available or can be readily synthesized.

As substituted cyclopentadienyl groups, mention may be made of those substituted either in the 2 (or 5) position or in the 3 (or 4) position, particularly those substituted in the 2 position, more particularly the tetramethylcyclopentadienyl group. Position 2 (or 5) denotes the position of the carbon atom which is adjacent to the carbon atom to which the bridge P is attached, as is represented in the diagram below. As a reminder, substitution in position 2 or 5 is also referred to as substitution in the a position relative to the bridge.

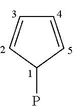

Mention may be made, as substituted fluorenyl groups, of those substituted with alkyl groups having 1 to 6 carbon atoms or with aryl radicals having 6 to 12 carbon atoms. The choice of the groups is also guided by the accessibility to the corresponding molecules, which are the substituted fluorenes, because the latter are commercially available or can be readily synthesized.

Mention may particularly be made, as substituted fluorenyl groups, of those substituted in position 2, 7, 3 or 6, more particularly 2,7-di(tert-butyl)fluorenyl and 3,6-di(tert-butyl)fluorenyl groups. Positions 2, 3, 6 and 7 respectively denote the positions of the carbon atoms of the rings as represented in the diagram below, position 9 corresponding to the carbon atom to which the bridge P is attached.

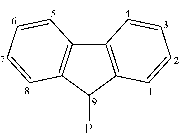

Mention may particularly be made, as substituted indenyl groups, of those substituted in position 2, more particularly 2-methylindenyl or 2-phenylindenyl. Position 2 denotes the position of the carbon atom which is adjacent to the carbon atom to which the bridge P is attached, as represented in the diagram below.

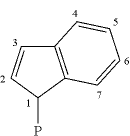

According to one embodiment of the invention Cp¹ and Cp² are different; one represents a cyclopentadienyl group and the other a fluorenyl group. This embodiment is particularly suitable for preparing a first block which does not contain any 1,2-cyclohexanediyl subunits of formula (I).

According to another embodiment of the invention, Cp¹ and Cp² are identical and are selected from the group consisting of substituted fluorenyl groups and the fluorenyl group. Advantageously, Cp¹ and Cp² each represent a substituted fluorenyl group or a fluorenyl group, preferably a fluorenyl group. The fluorenyl group is of formula C₁₃H₈. Preferably, the metallocene is of formula (IIa), (IIb), (IIc), (IId) or (IIe), in which the symbol Flu represents the fluorenyl group of formula C₁₃H₈.

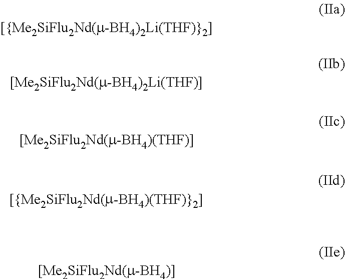

The organomagnesium compound used in the catalytic system as cocatalyst is a compound which has at least one C—Mg bond. Mention may be made, as organomagnesium compounds, of diorganomagnesium compounds, in particular dialkylmagnesium compounds, and of organomagnesium halides, in particular alkylmagnesium halides. A diorganomagnesium compound is typically of formula MgR³R⁴, wherein R³ and R⁴, which are identical or different, represent a carbon-based group. The term “carbon-based group” means a group which contains one or more carbon atoms. Preferably, R³ and R⁴ contain from 2 to 10 carbon atoms. More preferentially, R³ and R⁴ each represent an alkyl. The organomagnesium compound is preferentially a diorganomagnesium compound or an organomagnesium halide, advantageously a dialkylmagnesium compound, better still butylethylmagnesium or butyloctylmagnesium, even better still butyloctylmagnesium.

The catalytic system can be prepared conventionally by a process analogous to that described in patent application WO 2007/054224 A2 or WO 2007/054223 A2. For example, the organomagnesium compound and the metallocene are reacted in a hydrocarbon-based solvent typically at a temperature ranging from 20° C. to 80° C. for a period of between 5 and 60 minutes. The catalytic system is generally prepared in an aliphatic hydrocarbon-based solvent such as methylcyclohexane, or an aromatic hydrocarbon-based solvent such as toluene. Generally, after its synthesis, the catalytic system is used as is in the process for the synthesis of the block polymer.

Alternatively, the catalytic system can be prepared by a process analogous to that described in patent application WO 2017/093654 A1 or in patent application WO 2018/020122 A1. According to this alternative, the catalytic system further contains a preformation monomer chosen from a 1,3-diene, ethylene or a mixture of ethylene and a 1,3-diene, in which case the catalytic system is based at least on the metallocene, the organomagnesium compound and the preformation monomer. For example, the organomagnesium compound and the metallocene are reacted in a hydrocarbon-based solvent typically at a temperature of from 20° C. to 80° C. for 10 to 20 minutes, in order to obtain a first reaction product, and then the preformation monomer, chosen from a 1,3-diene, ethylene or a mixture of ethylene and a 1,3-diene, is reacted with this first reaction product at a temperature ranging from 40° C. to 90° C. for 1 h to 12 h. The preformation monomer is preferentially 1,3-butadiene or a mixture of ethylene and 1,3-butadiene. The catalytic system thus obtained can be used immediately in the process in accordance with the invention or be stored under an inert atmosphere before it is used in the polymerization process for preparing the block polymer.

The metallocene used for preparing the catalytic system can be in the form of a crystalline or non-crystalline powder, or else in the form of single crystals. The metallocene may be in monomer or dimer form, these forms depending on the method of preparation of the metallocene, as is described, for example, in patent application WO 2007/054224 A2 or WO 2007/054223 A2. The metallocene can be prepared conventionally by a process analogous to that described in patent application WO 2007/054224 A2 or WO 2007/054223 A2, in particular by reaction, under inert and anhydrous conditions, of the salt of an alkali metal of the ligand with a rare earth metal borohydride in a suitable solvent, such as an ether, for example diethyl ether or tetrahydrofuran, or any other solvent known to those skilled in the art. After reaction, the metallocene is separated from the reaction by-products by techniques known to those skilled in the art, such as filtration or precipitation from a second solvent. The metallocene is finally dried and isolated in solid form.

Like any synthesis carried out in the presence of an organometallic compound, the synthesis of the metallocene and that of the catalytic system take place under anhydrous conditions in an inert atmosphere. Typically, the reactions are performed starting with anhydrous solvents and compounds under anhydrous nitrogen or argon.

Those skilled in the art also adapt the polymerization conditions and the concentrations of each of the reagents (constituents of the catalytic system, monomers) according to the equipment (tools, reactors) used to perform the polymerization. As is known to those skilled in the art, the polymerization and the handling of the monomers, of the catalytic system and of the copolymerization solvent(s) take place under anhydrous conditions and in an inert atmosphere. The polymerization solvents are typically aliphatic or aromatic hydrocarbon-based solvents.

The polymerization is preferably performed in solution, continuously or discontinuously, in a reactor, advantageously a stirred reactor. The polymerization solvent can be an aromatic or aliphatic hydrocarbon-based solvent. Mention may be made, as examples of polymerization solvents, of toluene and methylcyclohexane. Advantageously, the polymerization is performed in solution in a hydrocarbon-based solvent such as methylcyclohexane.

Those skilled in the art adapt the polymerization conditions, such as the polymerization temperature, the concentration of each of the reagents and the pressure in the reactor, according to the composition of the monomer mixture, the polymerization reactor and the desired microstructure and macrostructure of the copolymer chain.

The first block is synthesized by the copolymerization of the ethylene and the 1,3-butadiene. The ethylene and the 1,3-butadiene can be introduced into the reactor containing the polymerization solvent and the catalytic system or, conversely, the catalytic system can be introduced into the reactor containing the polymerization solvent and the monomers, ethylene and 1,3-butadiene.

The polymerization temperature generally varies within a range of from 30° C. to 160° C., preferentially from 30° C. to 120° C. During the synthesis of the first block, the temperature of the reaction medium is advantageously kept constant during the polymerization and the total pressure in the reactor is also advantageously kept constant. Preferably, the monomer mixture of ethylene and the 1,3-butadiene is polymerized at a constant ethylene pressure.

To achieve the desired macrostructure of the first block, those skilled in the art adapt the polymerization conditions, notably the molar ratio of the organomagnesium reagent to the metal Nd constituting the metallocene. The molar ratio can reach the value of 100, it being known that a molar ratio of less than 10 is more favourable for obtaining polymers of high molar masses.

During the synthesis of the first block, ethylene and the 1,3-butadiene can be added continuously to the polymerization reactor, in which case the polymerization reactor is a fed reactor. This embodiment is most particularly suitable for the synthesis of a first block which is a statistical copolymer.

The synthesis of the first block is completed by cutting off the supply of monomers, in particular by a drop in the pressure of the reactor, preferably to around 3 bar. The reaction medium at the end of the synthesis of the first block is degassed, preferably by carrying out several degassings using an inert gas, for example nitrogen. The preparation of the block polymer is continued with the synthesis of the second block by subsequent homopolymerization of the vinylpyridine in the degassed reaction medium.

The vinylpyridine can be a mixture of vinylpyridines or one of the isomers of vinylpyridine, with the isomerism being determined by the substituted carbon of the aromatic ring of the pyridine. Preferably, the vinylpyridine is 4-vinylpyridine, 2-vinylpyridine or the mixture thereof. More preferentially, the vinylpyridine is 4-vinylpyridine. When the vinylpyridine is packaged in the presence of a stabilizer, as is the case for most commercial vinylpyridines, it is typically used after removal of the stabilizer, which can be carried out in a well-known manner by distillation or by contact with alumina, for example by treatment on alumina columns.

The vinylpyridine can be added to the reactor in pure form or diluted in a hydrocarbon-based solvent, preferably an aliphatic hydrocarbon-based solvent, such as methylcyclohexane. The pure or diluted vinylpyridine is introduced into the degassed reaction medium. The amount of vinylpyridine introduced into the reaction mixture, which is to be polymerized in form the second block, is adjusted by those skilled in the art according to the desired content of vinylpyridine in block form in the block polymer. It may vary within broad ranges, in particular from 0.01 to 25 g per 100 g of first block formed, more particularly from 2 g to 25 g per 100 g of block formed. The homopolymerization of the vinylpyridine is preferably carried out at a temperature identical to that of the synthesis of the first block. The polymerization temperature for the synthesis of the second block generally varies within a range of from 30 to 160° C., preferentially from 30 to 120° C. The synthesis of the second block can typically be followed by chromatographic analysis in order to monitor the consumption of the vinylpyridine. The synthesis of the second block is completed when the second block reaches the desired number-average molar mass or when the conversion of the reaction for polymerizing the vinylpyridine reaches the desired conversion, for example 100%.

The synthesis of the second block can be stopped by cooling the polymerization medium or by adding an alcohol, preferentially an alcohol containing from 1 to 3 carbon atoms, for example ethanol. The block polymer can be recovered according to conventional techniques known to those skilled in the art, for instance by precipitation, by evaporation of the solvent under reduced pressure or by steam stripping.

Preferably, the block polymer in accordance with the invention which can be prepared by the process in accordance with the invention is a diblock.

The block polymer can be added to a mineral base oil to form a lubricating composition, which is another subject of the invention. The constituent block polymer of the lubricating composition can be a mixture of block polymers as defined previously which differ from one another in terms of their respective composition.

Mention may be made, as suitable mineral base oils, of the group I base oils, group II base oils and group III base oils, and mixtures thereof. Groups I to III are defined, as is known, according to the American Petroleum Instititute (API) in their publication “API N^{o} 1509 Engine Oil Licensing and Certification System, Appendix E, 14th Edition”, December 1996. Mineral base oils are typically obtained by atmospheric and vacuum distillation of crude petroleum, optionally followed by refining operations.

The content of the block polymer added to the mineral base oil is adjusted by those skilled in the art depending on the nature of the mineral base oil, depending on the characteristics of the block polymer and, of course, depending on the use of the lubricating composition. The content by weight of the block polymer in the lubricating composition, or of the mixture of block polymers in the lubricating composition, can range up to 5% by weight of the lubricating composition, for example from 0.01% to 5% by weight of the lubricating composition, preferentially from 0.05% to 2% by weight of the lubricating composition. Preferably, the mineral base oil is a group I base oil.

The mixture formed by the base oil and the block polymer constitutes a lubricating composition which can furthermore contain other additives conventionally used in an engine oil, such as detergents and dispersants, antioxidants, compounds having an action against the formation of rust, of foam, of ice.

The lubricating composition in accordance with the invention has high temperature thickening properties, like the engine oils containing viscosity improvers which are conventionally used, such as copolymers of ethylene and propylene.

In summary, the invention is advantageously performed according to any one of the following embodiments 1 to 14:
Embodiment 1: Block polymer containing a first block and a second block, the first block being a copolymer of 1,3-butadiene and ethylene, containing more than 90 mol % of ethylene units, the molar percentage being expressed relative to the total number of constituent repeat units of the first block, the second block being a homopolymer of a vinylpyridine.
Embodiment 2: Block polymer according to embodiment 1, wherein the first block is a statistical copolymer of ethylene and 1,3-butadiene.
Embodiment 3: Block polymer according to either one of embodiments 1 to 2, which block polymer is a diblock.
Embodiment 4: Block polymer according to any one of embodiments 1 to 3, wherein the ethylene units present in the first block represent less than 97 mol % of the total number of constituent repeat units of the first block.
Embodiment 5: Block polymer according to any one of embodiments 1 to 4, wherein the first block contains 1,2-cyclohexanediyl subunits.
Embodiment 6: Block polymer according to embodiment 5, wherein the molar content of 1,2-cyclohexanediyl subunits in the first block is less than 10% of the total number of constituent repeat units of the first block.
Embodiment 7: Block polymer according to embodiment 5 or 6, wherein the molar content of 1,2-cyclohexanediyl subunits in the first block varies from 1% to less than 10% of the total number of constituent repeat units of the first block.
Embodiment 8: Block polymer according to any one of embodiments 1 to 7, wherein the vinylpyridine is 4-vinylpyridine, 2-vinylpyridine or the mixture thereof.
Embodiment 9: Block polymer according to any one of embodiments 1 to 8, wherein the molar content of vinylpyridine units present in the second block is greater than 0.1% of the total number of constituent repeat units of the first block.
Embodiment 10: Block polymer according to any one of embodiments 1 to 9, wherein the molar content of vinylpyridine units in the second block is less than 20% of the total number of constituent repeat units of the first block.
Embodiment 11: Lubricating composition comprising a mineral base oil and a block polymer as defined in any one of embodiments 1 to 10.
Embodiment 12: Lubricating composition according to embodiment 11, wherein the content by weight of the block polymer varies from 0.01% to 5% by weight of the lubricating composition.
Embodiment 13: Lubricating composition according to embodiment 11 or 12, wherein the content by weight of the block polymer varies from 0.05% to 2% by weight of the lubricating composition.
Embodiment 14: Lubricating composition according to any one of embodiments 11 to 13, wherein the mineral base oil is a group I base oil.

### EXAMPLES

### Determination of the Microstructure of the Polymers:

High resolution NMR spectroscopy of the polymers was carried out on a Bruker 600 Avance III HD spectrometer operating at 600 MHz equipped with a CP2.1 BBO 600S3 probe for the proton. The acquisitions are made at 368 K. ortho-dichlorobenzene (o-DCB) is used as solvent. The samples were analysed at a concentration of approximately 1% by weight for the proton NMR (¹H NMR) analyses. The chemical shifts are determined relative to the proton signal of ortho-dichlorobenzene, which is set at 7.2 ppm. A 2D analysis was performed using the following sequence: HSQC: Pulse program; hsqcetgpsi2 “HSQC with gradients”; SW1:180 ppm (¹³C); SW2:12 ppm (¹H); d1:10 s; 90° “hard” pulse ¹H P1=13 μs and 16 W and ¹³C P2=26 μs and 84 W; Gradient: SMSQ10.100.

The attribution of signals characteristic of the first block is defined in the literature, according to the paper by Llauro et al., Macromolecules, 2001, 34, 6304-6311.

The attribution of signals characteristic of the second block is defined as follows: δ¹H=8.29 ppm (═CH—N═CH—); δ¹H=6.34 ppm (═CH—C(CH₂)═CH—); δ¹³C=150 ppm (═CH—N═CH—); δ¹³C=6.34 ppm (═CH—C(CH₂)═CH—)

### DOSY NMR (Diffusion-Ordered Spectroscopy) Analysis of the Block Polymers:

The DOSY experiment, an NMR method, allows analysis of complex mixtures and detection of traces. The aim of this experiment is to show that the block polymer represents the majority of the sample and that the presence of homopolymers is very low, or absent.

The DOSY NMR analysis makes it possible to separate the species present, notably polymer matrices, by analysis of their solution diffusion coefficient. The principle of the technique is as follows:

The DOSY experiment consists in recording proton spectra while varying the force G of the gradients applied and thus the diffusion force. A linear increase in the intensity of the gradients brings about an exponential decrease in the intensity of the NMR signal. The DOSY experiment produces a two-dimensional map. The second dimension F2 of the DOSY corresponds, after Fourier transform treatment, to the 1H dimension. The first dimension F1 corresponds to the decrease of the NMR signal as a function of the applied gradient force. After treatment of the dimension F2, the diffusion coefficient is extracted using equation (1), and a DOSY map is obtained.

$$I = I 0. exp ( - D {γ}^{2} {G}^{2} {δ}^{2} ( Δ - δ / 3 ) ) \qquad ( 1 )$$

where I is the observed intensity, I0 the reference intensity, D the diffusion coefficient, γ the gyromagnetic ratio of the nucleus observed, G the force of the gradient, δ the length of the gradient, and Δ the diffusion time.

If the two matrices have an identical diffusion coefficient, this means that the two matrices have the same hydrodynamic radius and are thus grafted. On the other hand, if the two matrices have two different diffusion coefficients, this means that they are free with respect to each other.

The equation which describes the diffusion coefficient is as follows:

$$D = \frac{{k}_{B} T}{6 π η r s}$$

wherein k_{B} is the Boltzmann constant, T the temperature, η the viscosity of the liquid in which the molecule is found, rs the hydrodynamic radius of the molecule (in this instance the matrix or the polymer).

The experiment was performed on samples of poly(butadiene)-b-poly(ethylene-co-butadiene) synthesized according to the process in accordance with the invention.

The recording of two 1D ¹H NMR spectra with a diffusion filter, one with a magnetic field gradient set at 90% of the maximum power of the gradient amplifier and the other at 1% of this value, allows, by comparison with the ¹H NMR spectrum, to observe the proportion of signal loss due to the spatial diffusion of the molecules and to relaxation of the magnetization. The signal loss due to diffusion is then attributed to “small molecules” not grafted to the polymer matrix (reagents, antioxidants, solvents, etc.).

### Determination of the Macrostructure of the Polymers:

Size exclusion chromatography is used. It will be recalled that SEC makes it possible to separate macromolecules in solution according to their size through columns packed with a porous gel. The macromolecules are separated according to their hydrodynamic volume, the bulkiest being eluted first. Without being an absolute method, SEC makes it possible to understand the distribution of the molar masses of a polymer. The various number-average molar masses (Mn) and weight-average molar masses (Mw) can be determined from commercial standards and the dispersity (Ð=Mw/Mn) can be calculated via a “Moore” calibration.

Preparation of the polymer: There is no particular treatment of the polymer sample before analysis. It is simply dissolved in 1,2,4-trichlorobenzene containing 300 ppm of BHT (butylated hydroxytoluene), at a concentration of approximately 1 g/l. The solution is stirred at 160° C. for 2 h before injection and the chromatographic device used is equipped with an in-line filtration system.

SEC analysis: High temperature size exclusion chromatography or HT-SEC is used. The apparatus used is a GPC-IR chromatograph equipped with an IR-6 infrared detector from Polymer Char. Detection is carried out by the IR detector on the vibration bands of the CH₂ and CH₃ groups. A set of 3 “Mixed BN-LS” commercial reference columns from Polymer Char is used. The elution solvent is 1,2,4-trichlorobenzene containing 300 ppm of BHT, the flow rate is 1 ml/min, the temperature of the system is 160° C. and the analytical time is 90 minutes (min).

The volume injected of the solution of the polymer sample is 200 μl. The software for making use of the chromatographic data is the GPC-one system from Polymer Char.

The average molar masses are determined from a calibration curve produced from PSS Ready Cal-Kit commercial polystyrene standards.

Determination of the Degree of Crystallinity of the Polymers, their Melting Point and their Glass Transition Temperature:

The degree of crystallinity, the melting point and the glass transition temperature are determined by differential scanning calorimetry (DSC). The analyses are carried out on a Netzsch DSC 214 Polyma DSC device calibrated with indium. This device has a temperature range extending from −150° C. to 700° C. A computer integrated into the DSC controls the device using the Proteus software from Netzsch. The sample (approximately 10 mg) is weighed and sealed in a 40 μl aluminium crucible. The crucible is pierced with a fine needle just before the measurement. The samples are analysed under helium at 40 ml/min according to a dynamic method comprising 7 temperature steps:
Step 1: cooling from 25° C. to −150° C. at 50° C./min; Step 2: isothermal at −150° C. for 5 min;
Step 3: heating from −150° C. to 200° C. at 20° C./min; Step 4: isothermal at 200° C. for 5 min;
Step 5: cooling from 200° C. to −150° C. at 20° C./min; Step 6: isothermal at −150° C. for 5 minutes; Step 7: heating from −150° C. to 200° C. at 20° C./min.

The first four steps make it possible to erase the thermal history of the sample. The measurements of the glass transition temperature (Tg) and melting point (Tm) are carried out in the 7^{th} step. The 7^{th} step is also retained in order to obtain information on the crystallization of the sample and to determine the degree of crystallinity.

The Tg and Tm values are determined by applying the data reprocessing of the Proteus software from Netzsch. The degree of crystallinity is determined by using Standard ISO 11357-3:2011 to measure the temperature and enthalpy of fusion and crystallization of the polymers used by differential scanning calorimetry (DSC). The reference enthalpy of polyethylene is 293 J/g (source: B. Wunderlich, Thermal Analysis, Academic Press, 1990, 281).

### Synthesis of the Polymers:

All the reagents are obtained commercially except for the metallocene [{Me₂SiFlu₂Nd(μ-BH₄)₂Li(THF)}], which is prepared according to the procedure described in patent application WO 2007/054224.

The butyloctylmagnesium BOMAG (20% by weight in heptane, C=0.88 mol·l⁻¹) originates from Lanxess and is stored in a metal cylinder under an inert atmosphere. The ethylene, of N35 grade, is obtained from the company Air Liquide and is used without prior purification. The 1,3-butadiene is purified over alumina guard tubes. The methylcyclohexane solvent originating from BioSolve is dried and purified on an alumina column in a solvent purifier originating from mBraun and used in an inert atmosphere. All the reactions are carried out in an inert atmosphere.

Purification of the 4-vinylpyridine:

The purified 4-vinylpyridine is prepared according to the following procedure: 100 ml of 4-vinylpyridine (Sigma-Aldrich, 95% purity, containing 100 ppm of hydroquinone) are placed in a steinie bottle. 30 g of alumina are introduced into the bottle. The bottle is then capped and stirred for 60 minutes at ambient temperature (23° C.) in darkness.

Preparation of a Solution of 4-vinylpyridine in Methylcyclohexane:

Before being used to prepare the solutions, the methylcyclohexane (MCH) is purified by passing over alumina guard tubes.

A first solution of 4-vinylpyridine in MCH, solution A, is prepared by introducing 0.26 ml of purified 4-vinylpyridine into 20 ml of MCH contained in a capped 250 ml Steinie bottle under nitrogen pressure.

A second solution of 4-vinylpyridine in MCH, solution B, is prepared by introducing 0.65 ml of purified 4-vinylpyridine into 20 ml of MCH contained in a capped 250 ml Steinie bottle under nitrogen pressure.

The bottles containing solutions A and B, respectively, are pressurized at 3 bar nitrogen.

### Example 1: Preparation of a Block Polymer in Accordance with the Invention

30.4 mg (47.5 μmol) of the metallocene Me₂Si(C₁₃H₈)₂Nd(BH₄)₂Li·THF are weighed out in a 250 ml Steinie bottle in a glove box.

296 ml of MCH are introduced into a 750 ml Steinie bottle. The bottle is placed under an inert atmosphere by nitrogen bubbling for 10 minutes. 4.57 ml (499 μmol, Mg/Nd=10.5) of a solution of butyloctylmagnesium at 0.11 mol/l in MCH are introduced into the 750 ml bottle containing the MCH in order to form a solution C.

A mixture of ethylene monomer and 1,3-butadiene is also prepared, containing 92 mol % ethylene and 8 mol % 1,3-butadiene, by first injecting, into a ballast, 0.48 bar of 1,3-butadiene, then 5.52 bar of ethylene in order to supplement the gaseous mixture. 6 bar absolute of a mixture containing 92 mol % ethylene and 8 mol % 1,3-butadiene is obtained (ethylene/butadiene mixture: 92/8).

The ballast is connected to a polymerization reactor.

Approximately a third of the solution C is transferred into the 250 ml bottle containing the metallocene via a cannula in order to activate the metallocene and form the catalytic system.

Half of the solution C is introduced into the stirred (at 400 rpm) reactor and brought to 77° C., with the reactor having been previously placed under an inert atmosphere. The contents of the 250 ml bottle containing the catalytic system is introduced into the reactor. The rest of the solution C is then transferred into the reactor. The reactor is degassed under vacuum until gas bubbles form and is then pressurized to 3 bar with the ethylene/butadiene mixture: 92/8.

When the pressure of the ballast registers a pressure drop corresponding to 12.7 g of monomers, the reactor is degassed using 3 venting/nitrogen cycles.

Solution A containing the 4-vinylpyridine is introduced into the reactor. Stirring is maintained for 1 hour, then the heating is switched off and the stirring stopped. The reactor is disassembled, the polymerization medium is deactivated with 2 ml of ethanol to stop the polymerization reaction, and then is transferred into an aluminium tray and dried under vacuum at 60° C. in an oven for 24 h. The polymer recovered is white and opaque.

After 24 h, the dry polymer is recovered for the analyses. The block polymer is a diblock containing a first block of a statistical copolymer of ethylene and 1,3-butadiene and a second block of poly(4-vinylpyridine).

The first block of the block polymer contains 91 mol % of ethylene units, 6 mol % of 1,2-cyclohexanediyl units, 1 mol % of the 1,3-butadiene unit in the 1,2 configuration and 2 mol % of the 1,3-butadiene unit in the 1,4 configuration, predominantly 1,4-trans. The second block of poly(4-vinylpyridine) represents 0.5 mol % of the total number of ethylene units, of 1,2-cyclohexanediyl units, of 1,3-butadiene units in the 1,2 configuration and of 1,3-butadiene units in the 1,4-trans configuration. DOSY NMR analysis shows a diffusion coefficient that corresponds to the block polymer EBR-b-PVP. The block polymer, analysed by HT-SEC, has a number-average molar mass of 12 500 g/mol and a dispersity index of 1.88.

### Example 2: Preparation of a Block Polymer in Accordance with the Invention

A block polymer is prepared according to a procedure identical to that of example 1, with the sole difference being that solution A is replaced by solution B.

The first block of the block polymer contains 92 mol % of ethylene units, 5 mol % of 1,2-cyclohexanediyl units, 1 mol % of the 1,3-butadiene units in the 1,2 configuration and 2 mol % of the 1,3-butadiene units in the 1,4 configuration, predominantly 1,4-trans. The molar content of units of the 4-vinylpyridine is 1.4 mol % of the total number of ethylene units, of 1,2-cyclohexanediyl units, of 1,3-butadiene units in the 1,2 configuration and of 1,3-butadiene units in the 1,4 configuration, predominantly the 1,4-trans configuration.

The block polymer, analysed by HT-SEC, has a number-average molar mass of 12 000 g/mol and a dispersity index of 1.9.

The weighed mass of block polymer makes it possible to determine the mean catalytic activity of the catalytic system, expressed in kilograms of polymer synthesized per mole of neodymium metal and per hour (kg/mol·h). The catalytic activity is 214 kg·mol/h. The Tg of the polyvinylpyridine block is 160° C. The crystallinity of the block polymer is 36.8%.

### Example 3: Preparation of a Statistical Ethylene-1,3-butadiene Copolymer not in Accordance with the Invention

A polymer is prepared according to a procedure identical to that of example 1 and example 2 except that no vinylpyridine solution is added after the copolymerization of the ethylene and the 1,3-butadiene. When the pressure of the ballast registers a pressure drop corresponding to 12.7 g of monomers, the reactor is degassed using 3 venting/nitrogen cycles and the mixture is stopped with 2 ml of ethanol.

The polymer solution is then dried in an oven under vacuum at 60° C. and under nitrogen flushing for 24 h.

The weighed mass of copolymer makes it possible to determine the mean catalytic activity of the catalytic system, expressed in kilograms of polymer synthesized per mole of neodymium metal and per hour (kg/mol·h). The catalytic activity is 191 kg/mol·h.

HT-SEC analysis of the copolymer shows a monomodal molecular distribution and an Mn of 11 800 g/mol with a dispersity of 1.87.

The copolymer of ethylene and 1,3-butadiene contains 91 mol % of ethylene units, 6 mol % of 1,2-cyclohexanediyl units, 1 mol % of 1,3-butadiene units in the 1,2 configuration and 2 mol % of 1,3-butadiene units in the 1,4 configuration.

The Tg of the copolymer of ethylene and 1,3-butadiene is −21° C. The DSC thermogram shows an endothermic phenomenon when passing the transition temperature (−21° C.) identical to that of example 1 and example 2.

Example 3 is a control example, because it corresponds to the synthesis of the first block of examples 1 and 2.

### Preparation of the Lubricating Compositions Containing a Base Oil 600:

Lubricating compositions C0, C1 and C2 are prepared according to the following procedure:

1 g of polymer is introduced into a 250 ml steinie bottle containing 200 g of a CORE™ 600 group I mineral base oil. The steinie bottle is capped and stirred in a thermostatically controlled bath at 90° C. for 12 hours. The viscosity of the resulting mixture is measured at 100° C. For composition C1, the polymer is the block polymer of example 1; for composition C2, the polymer is the block polymer of example 2; for composition C0, the polymer is an OCP sold by Lubrizol under the reference 7077, which is a copolymer of ethylene and propylene containing approximately 50 mol % ethylene. The composition C0 containing a base oil 600 is a reference composition since it contains a copolymer not in accordance with the invention, the copolymer 7077 from Lubrizol, an additive commonly used in engine oils as high temperature (100° C.) thickening agent. The base oil Core™ 600 sold by Exxon is a group I mineral base oil and is commonly used as base oil in engine oils.

The kinematic viscosity of the lubricating compositions at 100° C. is measured according to standard ASTM 445-21. The viscosity results, given in base 100 relative to a control, are presented in table 1. The control consists of the same base oil which is used in the lubricating compositions.

TABLE 1

| Lubricating composition | T1 | C0 | C1 | C2 |
|---|---|---|---|---|
| Base oil | 600 | 600 | 600 | 600 |
| Polymer | — | OCP | Example 1 | Example 2 |
| Viscosity at 100° C. | 100 | 103 | 108 | 109 |

It is observed that the lubricating composition containing a block polymer in accordance with the invention (C1; C2) have a viscosity at 100° C. which is greater than that of the base oil that it contains (T1). The viscosities of the lubricating compositions C1 and C2 are higher than that of the reference composition C0. This result is obtained even though the copolymers according to the invention have a number-average molar mass which is much lower than that of the OCP copolymer. Surprisingly, as high temperature thickening agent for mineral base oils, the block polymers according to the invention prove to be as effective as an OCP copolymer.

What is claimed is:

1. A block polymer containing a first block and a second block, the first block being a copolymer of 1,3-butadiene and ethylene, containing more than 90 mol % of ethylene units, the molar percentage being expressed relative to the total number of constituent repeat units of the first block, the second block being a homopolymer of a vinylpyridine.

2. The block polymer according to claim 1, wherein the first block is a statistical copolymer of ethylene and 1,3-butadiene.

3. The block polymer according to claim 1, which block polymer is a diblock.

4. The block polymer according to claim 1, wherein the ethylene units present in the first block represent less than 97 mol % of the total number of constituent repeat units of the first block.

5. The block polymer according to claim 1, wherein the first block contains 1,2-cyclohexanediyl subunits.

6. The block polymer according to claim 5, wherein the molar content of 1,2-cyclohexanediyl subunits in the first block is less than 10% of the total number of constituent repeat units of the first block.

7. The block polymer according to claim 5, wherein the molar content of 1,2-cyclohexanediyl subunits in the first block varies from 1% to less than 10% of the total number of constituent repeat units of the first block.

8. The block polymer according to claim 1, wherein the vinylpyridine is 4-vinylpyridine, 2-vinylpyridine or the mixture thereof.

9. The block polymer according to claim 1, wherein the molar content of vinylpyridine units present in the second block is greater than 0.1% of the total number of constituent repeat units of the first block.

10. The block polymer according to claim 1, wherein the molar content of vinylpyridine units in the second block is less than 20% of the total number of constituent repeat units of the first block.

11. A lubricating composition comprising a mineral base oil and a block polymer as defined in claim 1.

12. The lubricating composition according to claim 11, wherein the mineral base oil is a group I base oil.
